(19) United States
(12) Patent Application Publication
(10) Pub. No.: US 2023/0318821 A1
(43) Pub. Date: Oct. 5, 2023

(54) PROCESSING METHOD AND CIRCUIT OF KEY DERIVATION BASED ON HMAC

(71) Applicant: REALTEK SEMICONDUCTOR CORP., Hsinchu (TW)

(72) Inventor: Jheng-Hao Ye, Hsinchu (TW)

(73) Assignee: REALTEK SEMICONDUCTOR CORP., Hsinchu (TW)

(21) Appl. No.: 17/880,215

(22) Filed: Aug. 3, 2022

(30) Foreign Application Priority Data
Mar. 9, 2022 (TW) 111108652

(51) Int. Cl. H04L 9/08; H04L 9/32; H04L 9/14

(52) U.S. Cl. CPC H04L 9/0866; H04L 9/14; H04L 9/3242

(57) ABSTRACT

A processing method and circuit of key derivation based on hash message authentication codes (HMAC) are provided. The processing circuit includes a memory and an HMAC processor. The HMAC processor performs the following steps: loading a plaintext file and an initial vector into an HMAC procedure during an initial operation round so as to generate a temporary vector and a common vector, generating a first combined block data according to the plaintext file and the temporary vector during at least one other operation round, loading the first combined block data and the common vector into the HMAC procedure so as to generate a new temporary vector, recursively performing the HMAC procedure on the new temporary vector and the common vector until all of the at least one other operation round is completed, and outputting the new temporary vector as a target key.

### CROSS-REFERENCE TO RELATED APPLICATION

This non-provisional application claims priority under 35 U.S.C. § 119(a) to Patent Application No. 111108652 filed in Taiwan, R.O.C. on Mar. 9, 2022, the entire contents of which are hereby incorporated by reference.

### BACKGROUND

### Technical Field

The instant disclosure relates to an encryption/decryption method and circuit, especially a processing method and circuit of key derivation based on hash message authentication codes (HMAC).

### Related Art

With the advance in communication technologies, the requirement of data security regarding communication content grows more important. Current data security is mainly based on the application of cryptography. Whether the adopted encryption system is symmetrical or asymmetrical cryptography-based, the strength of key is going to influence the robustness of encryption.

Deriving a short key into a key with a specific size can increase the strength of encryption. Although more robust keys imply higher reliability of encryption, the operand for the decryption also increases. As a result, performing key derivation and encryption/decryption brings burden to the overall operation of a computing unit with low computation capability.

### SUMMARY

In view of the above, the instant disclosure provides a processing method of key derivation based on hash message authentication codes (HMAC). The processing method comprises: loading a plaintext file and an initial vector into an HMAC procedure during an initial operation round so as to generate a temporary vector and a common vector; generating a first combined block data according to the plaintext file and the temporary vector during at least one other operation round; loading the first combined block data and the common vector into the HMAC procedure so as to generate a new temporary vector; recursively performing the HMAC procedure on the new temporary vector and the common vector until all of the at least one other operation round are completed; and outputting the new temporary vector as a target key. The processing method of key derivation based on HMAC can decrease operand related to the initial key so as to increase overall computation efficiency.

In the processing method according to one or some exemplary embodiments of the instant disclosure, the step of loading the plaintext file and the initial vector into the HMAC procedure during the initial operation round so as to generate the temporary vector and the common vector comprises: inputting an encrypted key and a salt; performing an XOR operation on a first padding data according to the salt so as to generate a first temporary key; performing the XOR operation on a second padding data according to the salt so as to generate a second temporary key; performing a digital digest on the first temporary key and the encrypted key so as to generate a third temporary key; and performing the digital digest on the second temporary key and the third temporary key so as to generate an initial key.

In the processing method according to one or some exemplary embodiments of the instant disclosure, the step of loading the plaintext file and the initial vector into the HMAC procedure during the initial operation round so as to generate the temporary vector and the common vector comprises: performing the XOR operation on the first padding data according to the initial key so as to generate a first temporary data; and performing the XOR operation on the second padding data according to the initial key so as to generate a second temporary data.

In the processing method according to one or some exemplary embodiments of the instant disclosure, the step of loading the plaintext file and the initial vector into the HMAC procedure during the initial operation round so as to generate the temporary vector and the common vector comprises: performing the XOR operation on the first padding data according to the initial key so as to generate a first temporary data; performing the XOR operation on the second padding data according to the initial key so as to generate a second temporary data; concatenating the first temporary data and the plaintext file so as to obtain the first combined block data; loading the initial vector and performing the digital digest on the first combined block data so as to generate a third temporary data; combining the second temporary data and the third temporary data so as to obtain a second combined block data; and loading the initial vector and performing the digital digest on the second combined block data so as to generate the new temporary vector.

The instant disclosure provides a processing circuit of key derivation based on HMAC. The processing circuit comprises a memory and an HMAC processor. The HMAC processor performs an HMAC procedure on a plaintext file and an initial vector during an initial operation round so as to generate a temporary vector and a common vector, stores the temporary vector and the common vector into the memory during the initial operation round, generates a first combined block data according to the plaintext file and the temporary vector during at least one other operation round, and loads the first combined block data and the common vector into the HMAC procedure so as to generate a new temporary vector. Wherein the HMAC processor recursively performs the HMAC procedure on the new temporary vector and the common vector until all of the at least one other operation round are completed and then output the new temporary vector as a target key.

In some exemplary embodiments, the HMAC processor performs a digital digest on the first combined block data according to the initial vector so as to generate a third temporary data, combines the second temporary data and the third temporary data so as to obtain a second combined block data, and performs the digital digest on the second combined block data according to the initial vector so as to generate the new temporary vector.

According to one or some exemplary embodiments of the instant disclosure, the processing method and circuit of key derivation based on HMAC can decrease operand related to the initial key so as to increase overall computation efficiency of key derivation based on HMAC.

### BRIEF DESCRIPTION OF THE DRAWINGS

The disclosure will become more fully understood from the detailed description given herein below for illustration only, and thus not limitative of the disclosure, wherein:

FIG. 1 illustrates a schematic diagram of a processing circuit of key derivation based on HMAC according to an exemplary embodiment of the instant disclosure;

FIG. 2 illustrates a flowchart of a processing method of key derivation based on HMAC according to an exemplary embodiment of the instant disclosure;

FIG. 3 illustrates a schematic diagram of the generation of a first combined block data according to an exemplary embodiment of the instant disclosure;

FIG. 4 illustrates a schematic diagram of inputs and outputs of all stages of different operation rounds according to an exemplary embodiment of the instant disclosure;

FIG. 5 illustrates a flowchart of the obtaining of an initial key according to an exemplary embodiment of the instant disclosure;

FIG. 6 illustrates a flowchart of the generation of a first temporary data and a second temporary data according to an exemplary embodiment of the instant disclosure; and

FIG. 7 illustrates a block diagram of a processing circuit of key derivation based on HMAC and a multiplexer according to an exemplary embodiment of the instant disclosure.

### DETAILED DESCRIPTION

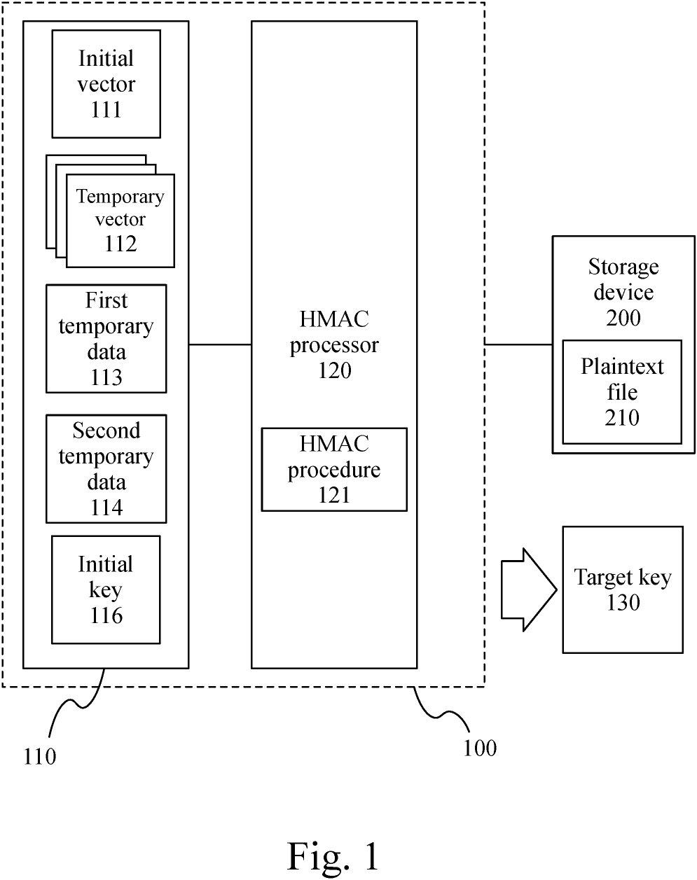

Please refer to FIG. 1. FIG. 1 illustrates a schematic diagram of a processing circuit of key derivation based on HMAC according to an exemplary embodiment of the instant disclosure. The processing circuit of key derivation based on HMAS 100 (referred to as the HKDF (hash message authentication codes based key derivation function) processing circuit 100 hereinafter) at least comprises a memory 110 and an HMAC (keyed-hash message authentication code) processor 120. The HKDF processing circuit 100 may be an independent circuit or may be a circuit integrated in a computer, a notebook computer, a mobile device, a tablet, or any electronic device having computation capability. The HMAC processor 120 is adapted to perform the operation of an HMAC procedure 121 and output a target key 130.

The HMAC processor 120 is electrically connected to the memory 110. The memory 110 stores an initial vector 111, at least one temporary vector 112, a first temporary data 113, a second temporary vector 114 (the generation and processing of the first temporary data 113 and the second temporary data 114 will be illustrated later), and an initial key 116. The memory 110 may be, but not limited to, a random access memory (RAM), an electrically-erasable programmable read-only memory (EEROM), a register, a hard drive, a solid-state drive (SSD), or relevant devices having storage capability.

The HMAC processor 120 reads the initial vector 111, the first temporary data 113, the second temporary data 114, and a plaintext file 210 at the memory 110. The HMAC processor 120 performs the HMAC procedure 121 based on the initial vector 111, the first temporary data 113, the second temporary data 114, and the plaintext file 210.

In general, during each of the operation rounds, the HMAC procedure 121 considers an output result of a previous operation round (i.e., in this embodiment, an operation round that is immediately prior to a current operation round) an input parameter (will be illustrated later) and generates an output result of the current operation round, and the output result of an operation round is called the temporary vector 112. In order to differentiate different operation rounds, in this embodiment, a first operation round is defined as the initial operation round, and the other operation rounds are defined as other operation rounds. During the initial operation round, the HMAC procedure 121 performs operation on the plaintext file 210 and the initial vector 111.

In order to illustrate input data and output data of different operation rounds, parameters are defined and explained as the following. The operation round is denoted as R(n). For example, the initial operation round is R(1), and the other operation rounds are R(2-n). The temporary vector of the operation round is denoted as T(n), where n € {1,2,..,n}, and n denotes a number of operation round.

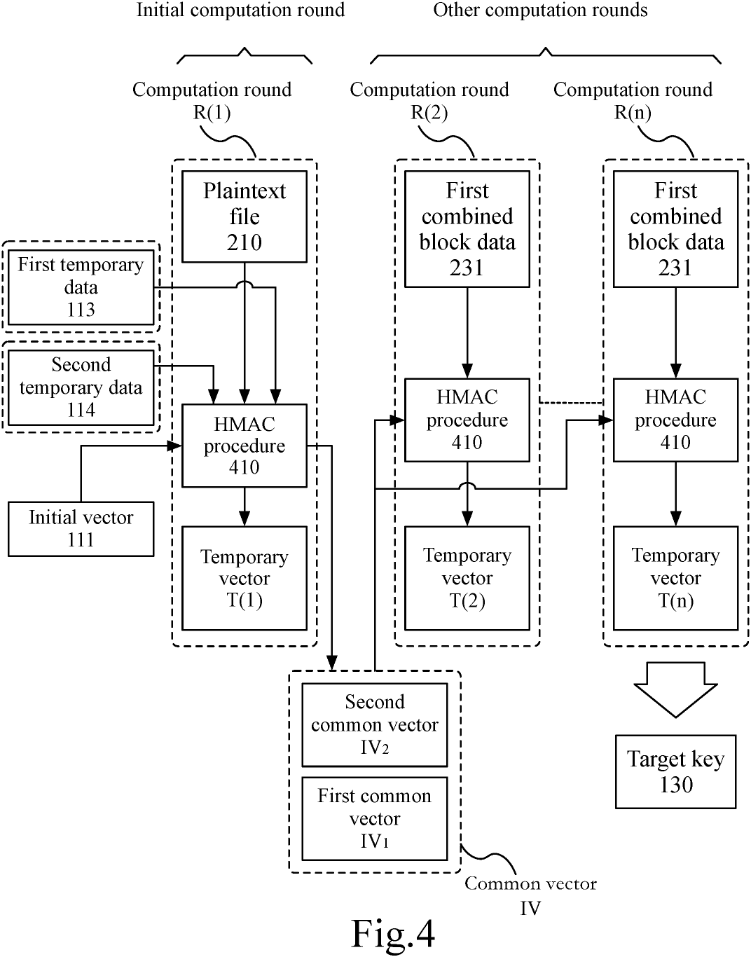

During the initial operation round (namely, the operation round R(1)), the HKDF processing circuit 100 obtains the initial vector 111 from the exterior and stores the initial vector 110 into the memory 110 to await the initial vector to be read by the HMAC processor 120. Beside the initial vector 111, the memory 110 also stores a common vector IV (as shown in FIG. 4) during operation. The common vector IV is a collection of a first common vector IV₁ and a second common vector IV₂. During the other operation rounds of a digital digest 241, the first common vector IV₁ and the second common vector IV₂ are utilized. This procedure will be illustrated later.

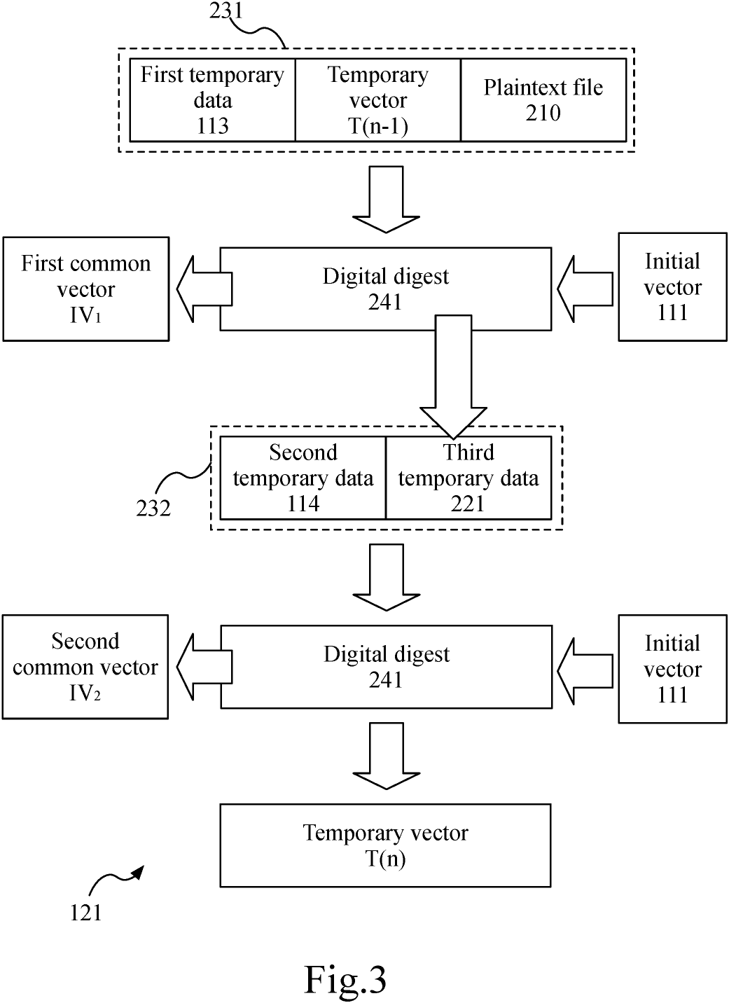

In an exemplary embodiment, the HMAC processor 120 is electrically connected to a storage device 200, as shown in FIG. 1. The storage device 200 stores the plaintext file 210. The plaintext file 210 may be, but not limited to, a text file, an image file, a video file, or other digital data. In general, during other operation rounds R(2-n), the HMAC processor 120 concatenates the plaintext file 210 and the temporary vector T(n-1) as a first combined block data 231 (as shown in FIG. 3).

During the initial operation round R(1), because a previous operation round R(0) does not exist, the HMAC processor 120 directly loads the plaintext file 210 as the temporary vector T(0) of the initial operation round R(1). The HMAC processor 120 performs a secure has algorithm (SHA) so as to split a concatenation result (i.e., in this embodiment, the result of the HMAC processor 120 concatenating the plaintext file 210 and the temporary vector T(n-1)), so that all split block data (i.e., in this embodiment, all split data obtained by The HMAC processor 120 splitting the concatenation result) are block data having identical sizes.

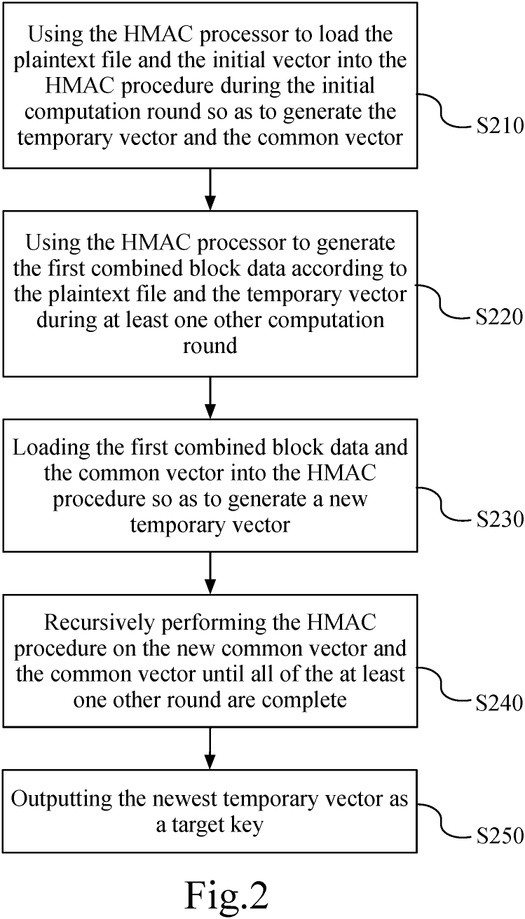

During operation rounds R(1-n), the HMAC processor 120 performs the HMAC procedure on the initial vector 111 and the plaintext file 210. Please refer to FIG. 2. FIG. 2 illustrates a flowchart of a processing method of key derivation based on HMAC according to an exemplary embodiment of the instant disclosure. According to one or some exemplary embodiments of the instant disclosure, the HMAC procedure comprises the following steps:
Step S210: the plaintext file and the initial vector are loaded into the HMAC procedure during the initial operation round so as to generate the temporary vector and the common vector;
Step S220: the first combined block data is generated according to the plaintext file and the temporary vector during at least one other operation round;
Step S230: the first combined block data and the common vector are loaded into the HMAC procedure so as to generate a new temporary vector;
Step S240: the HMAC procedure is recursively performed on the new temporary vector and the common vector until all of the at least one other operation round are completed; and
Step S250: the newest temporary vector is outputted as a target key.

At the start of the initial operation round, the HMAC processor 120 reads the plaintext file 210, the initial vector 111, the first temporary data 113, and the second temporary data 114 at the memory 110. The HMAC processor 120 will then perform the initial operation round R(1). The first temporary data 113 and the second temporary data 114 may be obtained during the initial operation round R(1) or before the initial operation round R(1) according to the initial key 116. Here, for illustrative purposes, the first temporary data 113 and the second temporary data 114 are already obtained before the initial operation round R(1).

Please refer to FIG. 3. FIG. 3 illustrates a schematic diagram of the generation of the first combined block data according to an exemplary embodiment of the instant disclosure. In general, the HMAC procedure 121 concatenates the first temporary data 113, the temporary vector T(n-1), and the plaintext file 210 so as to obtain the first combined block data 231. As illustrated above, because the temporary vector T(0) (i.e., when n = 1, T(n-1) does not exist) and the first temporary date 113 do not exist during the initial operation round R(1), the HMAC processor 120 can directly consider the plaintext file 210 as the temporary vector T(0) of the initial operation round R(1). The generation of first temporary data 113 and the second temporary data 114 will be illustrated later.

The HMAC processor 120 performs the digital digest 241 on the first combined block data according to the initial vector 111 so as to obtain a third temporary data 221 and the first common vector IV₁. In an exemplary embodiment, the digital digest 241 is message-digest (MD) algorithm, SHA, or message authentication code (MAC) algorithm.

The HMAC processor 120 combines the second temporary data 114 and the third temporary data 221 so as to obtain a second combined block data 232. The HMAC processor 120 performs the digital digest 241 on the second combined block data according to the initial vector 111 so as to obtain the temporary vector T(1) (when n = 2) and the second common vector IV₂. The HMAC stores the temporary vector T(1) into the memory 110, as shown in FIG. 4.

During the initial operation round R(1), the HMAC processor 120 respectively performs the digital digest 241 on the first temporary data 113 and the second temporary data 114 so as to obtain two output results. The two output results are the first common vector IV₁ and the second common vector IV₂ (i.e., the common vector IV). The first common vector IV₁ and the second common vector IV₂ will be directly loaded during each later operation round R(n).

Next, the HMAC processor 120 performs a second operation round R(2), which is one of the other operation rounds. The HMAC processor 120 performs the HMAC procedure 410 of the second operation round R(2) on the first combined block data 231, the first common vector IV₁, and the second common vector IV₂. Please refer to FIG. 4. FIG. 4 illustrates a schematic diagram of inputs and outputs of all stages of different operation rounds according to an exemplary embodiment of the instant disclosure.

The HMAC processor 120 recursively performs the aforementioned actions so as to obtain output temporary vectors T(2)-T(n) of all operation rounds R(2)-R(n). In general, the number of times of recursively execution of the HMAC processor 120 can be added or subtracted according to a default number of times of the HMAC procedure 121 or according to the number of times of the operation rounds executed by the HMAC processor 120. The HMAC processor 120 adds the output temporary vector T(n-1) of each of the operation rounds R(n-1) to the first combined block data 231 of the next operation round R(n). The HMAC processor 120 also directly loads the first common vector IV₁ and the second common vector IV₂ during each of the other operation rounds (2-n). As a result, the HMAC processor 120 can reduce repetitive operations of the other operation rounds. Last, the HMAC processor 120 outputs the temporary vector T(n) (i.e., the newest temporary vector) of the final operation round R(n) as a target key 130, as shown in FIG. 4. In other words, in this embodiment, the temporary vector obtained during the final operation round R(n), which is the newest temporary vector and is denoted by T(n), is outputted as the target key 130.

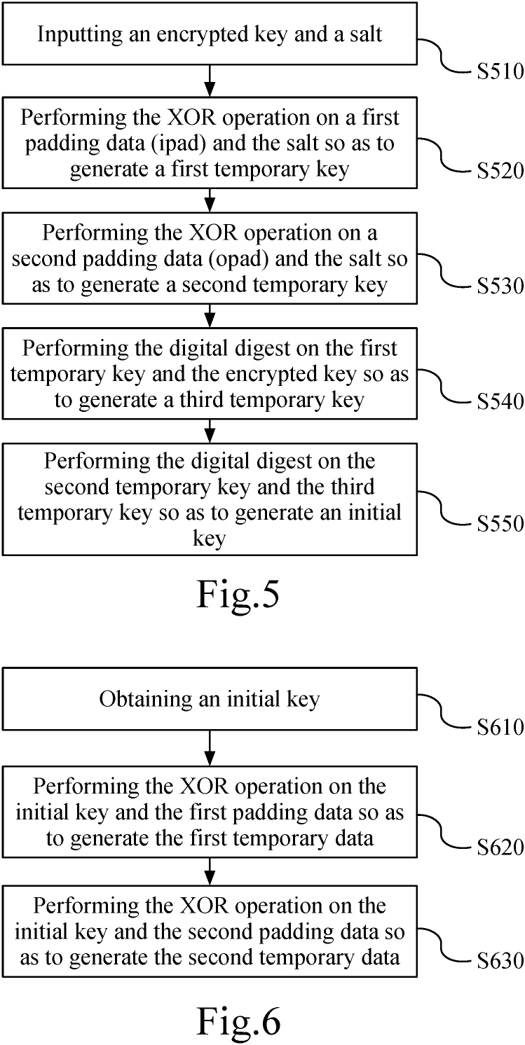

In an exemplary embodiment, the HMAC processor 120 can consider an input key (which is a pseudorandom key, PRK) as an initial key 116. The HMAC processor 120 can perform the following procedure on the obtained key (not labeled) so as to generate the initial key 116 (as shown in FIG. 1). Please refer to FIG. 5. FIG. 5 illustrates a flowchart of the obtaining of an initial key according to an exemplary embodiment of the instant disclosure. According to one or some exemplary embodiments of the instant disclosure, the HMAC processor 120 performs the following steps:
Step S510: an encrypted key and a salt is inputted;
Step S520: the XOR operation is performed on a first padding data (ipad) and the salt so as to generate a first temporary key;
Step S530: the XOR operation is performed on a second padding data (opad) and the salt so as to generate a second temporary key;
Step S540: the digital digest is performed on the first temporary key and the encrypted key so as to generate a third temporary key; and
Step S550: the digital digest is performed on the second temporary key and the third temporary key so as to generate an initial key.

First, the HMAC processor 120 receives the encrypted key. The HMAC processor 120 performs the XOR operation on the salt and the first padding data so as to generate the first temporary key. In general, the first padding data is a data block used to fill “0x36”, and the size of the first padding data is 8 bits times an integer. For example, the size of the first padding data may be 8 bits, 16 bits, or 32 bits.

Similarly, the HMAC processor 120 performs the XOR operation on the salt and the second padding data so as to generate the second temporary key. The second padding data is a data block used to fill “0x5c”, and the size of the second padding data is identical to the size of the first padding data. In practice, the filled content may be changed according to requirements, and the disclosure is not limited thereto.

The HMAC processor 120 performs the digital digest 241 on the first temporary key and the encrypted key so as to generate the third temporary key. The HMAC processor 120 performs the digital digest 241 on the second temporary key and the third temporary key so as to generate the initial key 116.

In an exemplary embodiment, the computation of the first temporary data 113 and the second temporary data 114 by the HMAC processor 120 comprises the following steps. Please refer to FIG. 6. FIG. 6 illustrates a flowchart of the generation of a first temporary data and a second temporary data according to an exemplary embodiment of the instant disclosure. According to one or some exemplary embodiments of the instant disclosure, the HMAC processor 120 performs the following steps:
Step S610: an initial key is obtained;
Step S620: the XOR operation is performed on the initial key and the first padding data so as to generate the first temporary data; and
Step S630: the XOR operation is performed on the initial key and the second padding data so as to generate the second temporary data.

First, the HMAC processor 120 obtains the initial key 116. The HMAC processor performs the XOR operation on the initial key 116 and the first padding data so as to generate the first temporary data 113. The HMAC processor 120 performs the XOR operation on the initial key 116 and the second padding data so as to generate the second temporary data 114.

Next, the HMAC processor 120 stores the first temporary data 113 and the second temporary data 114 into the memory 110. During other operation rounds, the HMAC processor 120 can directly access the first temporary data 113 and the second temporary data 114 at the memory 110. In other words, in this embodiment, the HMAC processor 120 does not need to compute the first temporary data 113 and the second temporary data 114 during all operation rounds.

Upon obtaining the initial key 115, the HMAC processor 120 can immediately compute the first temporary data 113 and the second temporary data 114. Alternatively, in some embodiments, the HMAC processor 120 can obtain the first temporary data 113 and the second temporary data 114 according to the initial key 116 during the first operation round R(1). The HMAC processor 120 then stores the first temporary data 113 and the second temporary data 114 into the memory 110 for later use during the other operation rounds.

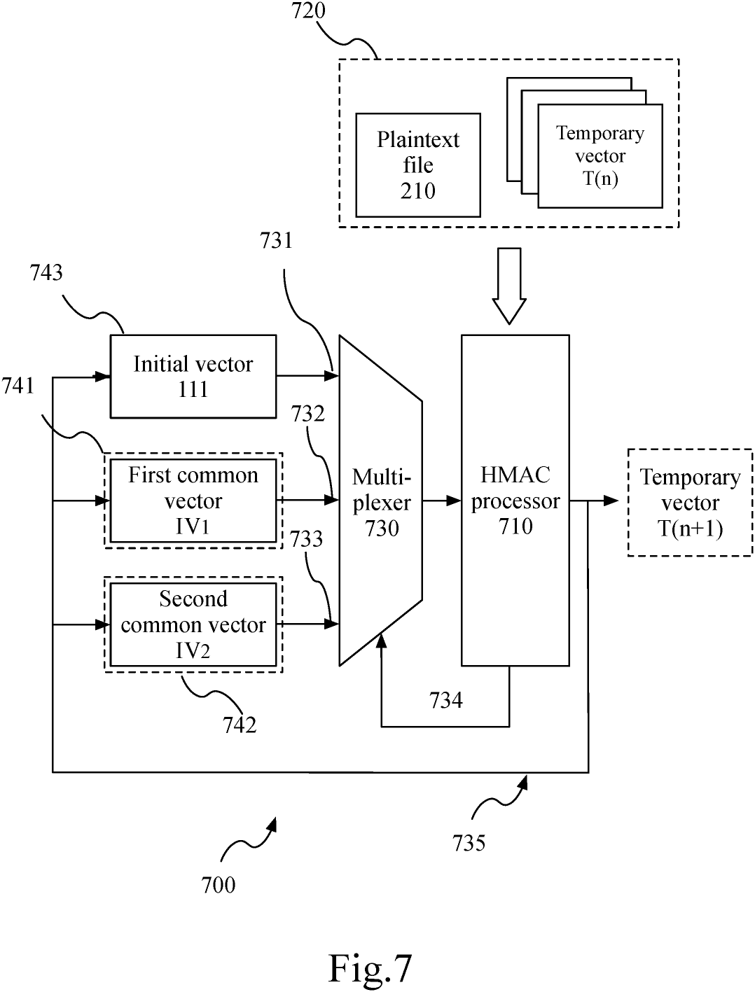

Please refer to FIG. 7. FIG. 7 illustrates a block diagram of a processing circuit of key derivation based on HMAC and a multiplexer 730 according to an exemplary embodiment of the instant disclosure. In an exemplary embodiment, the HKDF processing circuit 700 comprises an HMAC processor 710, a memory 720, and a multiplexer 730. The memory 720 stores the plaintext file 210, the first temporary data 113, and the second temporary data 114 (not shown in the figure). Input ends of the multiplexer 730 comprises a first input end 731, a second input end 732, and a third input end 733.

The first input end 731 is electrically connected to a third register 743 and receives the initial vector. The second input end 732 is electrically connected to a first register 741 and receives the first common vector IV₁. The third input end 733 is electrically connected to a second register 742 and receives the second common vector IV₂. An output end 735 of the multiplexer 730 is electrically connected to the HMAC processor 710. During different operation rounds, the output end 735 can selectively output the first common vector IV₁ or the second common vector IV₂ according to a selection signal 734. Besides, upon outputting the first common vector IV₁ or the second common vector IV₂, at the same time the output end 735 outputs the initial vector to the HMAC processor 710.

As illustrated above, before the initialization of the initial operation round R(1), the HKDF processing circuit 700 loads the initial vector 111, the initial key 116, and the plaintext file 210 from the memory 720. During the operation round R(1), the HMAC processor 710 generates a first temporary data 113 and a second temporary data 114 according to the initial key. After the initial operation round R(1) is completed, the HMAC processor 710 generates the first common vector IV₁, the second common vector IV₂, and the temporary vector T(1). The HMAC processor 710 respectively stores the first common vector IV₁ and the second common vector IV₂ into the first register 741 and the second register 742. During each of the later operation rounds, the HMAC processor 710 can directly obtain the first common vector IV₁ and the second common vector IV₂ required by the current operation round via the multiplexer 730 so as to reduce repetitive operation.

In summary, according to one or some exemplary embodiments of the instant disclosure, the processing method and circuit of key derivation based on HMAC can decrease operand related to the initial key so as to increase overall computation efficiency of key derivation based on HMAC.

What is claimed is:

1. A processing method of key derivation based on hash message authentication codes, the processing method comprising:
loading a plaintext file and an initial vector into an HMAC procedure during an initial operation round so as to generate a temporary vector and a common vector;
generating a first combined block data according to the plaintext file and the temporary vector during at least one other operation round;
loading the first combined block data and the common vector into the HMAC procedure so as to generate a new temporary vector;
recursively performing the HMAC procedure on the new temporary vector and the common vector until all of the at least one other operation round are completed; and
outputting the new temporary vector as a target key.

2. The processing method according to claim 1, wherein the step of loading the plaintext file and the initial vector into the HMAC procedure during the initial operation round so as to generate the temporary vector and the common vector comprises;
inputting an encrypted key and a salt;
performing an XOR operation on a first padding data according to the salt so as to generate a first temporary key;
performing the XOR operation on a second padding data according to the salt so as to generate a second temporary key;
performing a digital digest on the first temporary key and the encrypted key so as to generate a third temporary key; and
performing the digital digest on the second temporary key and the third temporary key so as to generate an initial key.

3. The processing method according to claim 2, wherein the step of loading the plaintext file and the initial vector into the HMAC procedure during the initial operation round so as to generate the temporary vector and the common vector comprises;
performing the XOR operation on the first padding data according to the initial key so as to generate a first temporary data; and
performing the XOR operation on the second padding data according to the initial key so as to generate a second temporary data.

4. The processing method according to claim 3, wherein the step of generating the first temporary data and the second temporary data comprises:
generating a first common vector and a second common vector according to the common vector;
storing the first common vector into a first register; and
storing the second common vector into a second register.

5. The processing method according to claim 4, wherein the step of performing the HMAC procedure comprises;
concatenating the first temporary data and the plaintext file so as to obtain the first combined block data;
loading the initial vector and performing the digital digest on the first combined block data so as to generate a third temporary data;
combining the second temporary data and the third temporary data so as to obtain a second combined block data; and
loading the initial vector and performing the digital digest on the second combined block data so as to generate the new temporary vector.

6. The processing method according to claim 5, wherein the digital digest is message digest (MD) algorithm, secure hash algorithm (SHA), or message authentication code (MAC) algorithm.

7. The processing method according to claim 1, wherein the step of recursively performing the HMAC procedure on the new temporary vector and the common vector until all of the at least one other operation round are completed comprises: storing the newest temporary vectors in a memory according to a sequence of generation of the temporary vectors.

8. A processing circuit of key derivation based on hash message authentication codes, the processing circuit comprising:
a memory; and
an HMAC processor, wherein the HMAC processor performs an HMAC procedure on a plaintext file and an initial vector during an initial operation round so as to generate a temporary vector and a common vector, stores the temporary vector and the common vector into the memory, generates a first combined block data according to the plaintext file and the temporary vector during at least one other operation round, and loads the first combined block data and the common vector into the HMAC procedure so as to generate a new temporary vector,
wherein the HMAC processor recursively performs the HMAC procedure on the new temporary vector and the common vector until all of the at least one other operation round are completed and then output the new temporary vector as a target key.

9. The processing circuit according to claim 8 further comprising a storage device, wherein the storage device stores the plaintext file, the HMAC processor is electrically connected to the storage device, and the HMAC processor concatenates a first temporary data and the plaintext so as to obtain the first combined block data.

10. The processing circuit according to claim 9, wherein the HMAC processor receives an initial key, performs an XOR operation on a first padding data and a second padding data according to the initial key so as to generate a first temporary data and a second temporary data, respectively, and stores the first temporary data and the second temporary data into the memory.

11. The processing circuit according to claim 9, wherein the HMAC processor performs a digital digest on the first combined block data according to the initial vector so as to generate a third temporary data, combines the second temporary data and the third temporary data so as to obtain a second combined block data, and performs the digital digest on the second combined block data according to the initial vector so as to generate the new temporary vector.

12. The processing circuit according to claim 11 further comprising a multiplexer, wherein the multiplexer is electrically connected to the HMAC processor, a first register, and a second register, and the HMAC processor generates a selection signal to the multiplexer so as to enable the multiplexer to select the first temporary data or the second temporary data for the HMAC processor.

13. The processing circuit according to claim 9, wherein the HMAC processor stores the new temporary vectors into the memory according to a sequence of generation of the temporary vectors.
